(19) United States
(12) Patent Application Publication
(10) Pub. No.: US 2009/0174685 A1
(43) Pub. Date: Jul. 9, 2009

(54) SYSTEM FOR CONTROLLING AN AUDIO-VIDEO SYSTEM

(76) Inventor: Albert Langella, White Plains, NY (US)

Correspondence Address: MARC E. HANKIN, ESQ., 11414 THURSTON CIRCLE, LOS ANGELES, CA, 90049, US

(21) Appl. No.: 11/969,215

(22) Filed: Jan. 3, 2008

(51) Int. Cl. G06F 3/045; G06F 3/042

(52) U.S. Cl. 345/174; 340/815.45

(57) ABSTRACT

Various embodiments of this invention are directed towards a system for controlling audio-video equipment, the lighted displays for audio-video equipment, and decorative lighted displays for audio-video equipment using one or more portions of the transparent area for the lighted display itself. Various embodiments of the invention disclose an audio-video unit featuring a transparent cover plate at the front of the audio-video unit, which may be used as an interface between the user and the controls of the audio-video unit.

### FIELD OF INVENTION

Various embodiments of this invention relate, generally, to display systems for audio-video systems; more particularly, to systems and methods for controlling the displays of audio-video systems.

### BACKGROUND

In the art of audio-video system design, various systems and methods are employed to display information for the user and to allow the user to control the parameters of the audio-video equipment. The front space of audio-video systems is somewhat limited and valuable to designer of audio-video systems because it customarily serves as the interface with the user.

Lighted control displays are commonly employed in audio-video systems that are used in dark spaces; for example, in home-theater systems that are used in the dark. Various types of lighted displays and information screens are known in the art. For example, LCD and LED displays are commonly employed in order to allow controls to be viewed in the dark and to display information about the audio-video unit's operation. Decorative lighted displays may also be used in order to provide design enhancements to the unit. For example, colored and evolving colored lighting may be used in order to provide enhanced appearance to the audio-video unit.

Because the controls on the audio-video units are generally opaque, the controls generally cannot be combined to occupy the same space as the lighted displays on audio-video units. Also, for units that employ decorative lighted displays, separate controls must be placed outside of the decorative lighted display in order to control in the decorative lighted display. Therefore, the designs of audio-video systems are somewhat limited in the ability to combine lighted displays and controls.

Thus, there remains a long felt need in the art for a system for controlling audio-video systems and the displays for audio-video systems, which places the controls at the same space as a lighted display or a decorative lighted display.

### SUMMARY OF THE INVENTION

Various embodiments of this invention are directed towards a system for controlling audio-video equipment, the lighted displays for audio-video equipment, and decorative lighted displays for audio-video equipment using one or more portions of the transparent area for the lighted display itself.

In various embodiments of the invention, the system comprises a transparent cover plate for portions of the front panels of the audio-video unit. The transparent cover plate is used to display information or decorative displays from various lighting sources within the unit. In various embodiments of the invention, the unit features one or more LEDs at the edges of the transparent cover plates, which illuminate the transparent cover plate and other areas of the audio-video unit.

Behind the transparent cover plate, the unit features one or more control sections, which are configured to receive input signals from a user. The control sections comprise capacitive touch sensors, which are receptive to inputs when the transparent cover plate is touched or pressed by a user.

In this manner, various embodiments of the invention disclose a system for controlling audio-video systems and the displays for audio-video systems, which places the controls at the same space as a lighted display or a decorative lighted display.

### BRIEF DESCRIPTION OF THE DRAWINGS

FIG. 1 is an audio-video unit that utilizes various embodiments of the invention shown from a perspective view.

FIG. 2 is an audio-video unit that utilizes various embodiments of the invention shown from a top view.

FIG. 3 is an audio-video unit that utilizes various embodiments of the invention shown from a cross-sectional view.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, “audio-video unit” refers to any of various pieces of audio or video equipment used in audio and video systems, such as radio receivers, AV Receivers, compact disc (CD) players, tape recorders, amplifiers, pre-amplifiers, mixing consoles, effects units, home theater systems, digital video disc (DVD) players and other such optical disc storage players, video home system (VHS) players and other such analog tape players, and other such audio-video units known in the art; “transparent cover plate” refers to any glass, acrylic glass, plastic, or other such transparent material known in the art.

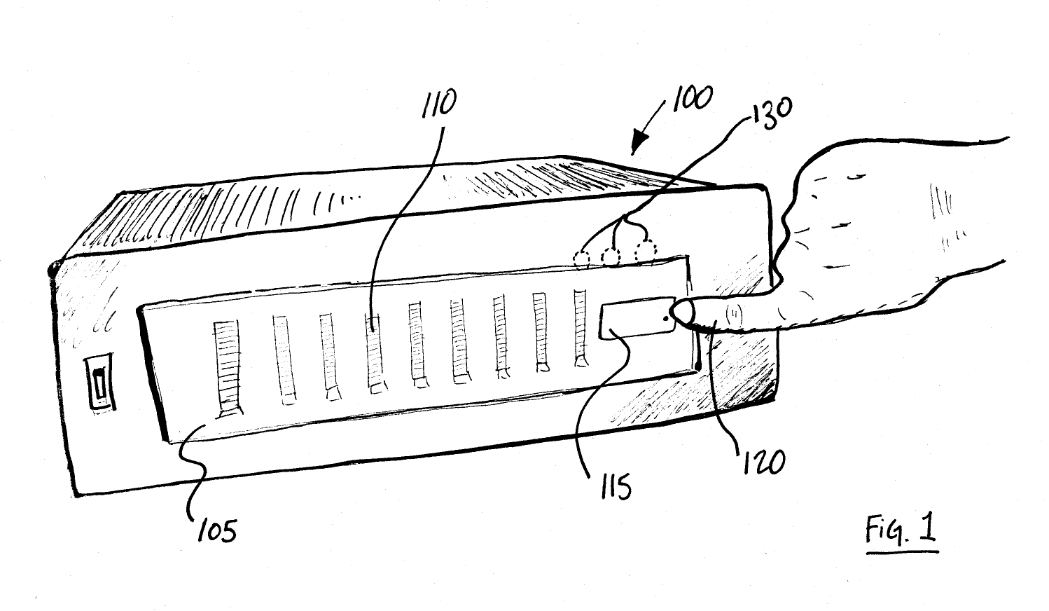

FIG. 1 is an audio-video unit 100 that utilizes various embodiments of the invention shown from a perspective view. An audio-video unit 100 is shown along with its constituent parts, including a transparent cover plate 105. Volume meters 110 are visible through the transparent cover plate 105. Portions of the area behind the transparent cover plate 105, feature one or more capacitive touch sensors 115. The capacitive touch sensor 115 is activated by a user's finger 120 touching the portion of the transparent cover plate 105 over the capacitive touch sensor 115.

Above the transparent cover plate 105, hidden from the user's view, the audio-video unit 100 features one or more LEDs 130, which illuminate the transparent cover plate 105. In various embodiments of the invention, the edges of the transparent cover plate 105 adjacent to the LEDs 130 are frosted, in order to better distribute the light from the LEDs 130. The transparent cover plate 105 may further feature frosting in various visible locations in order to communicate information to the user.

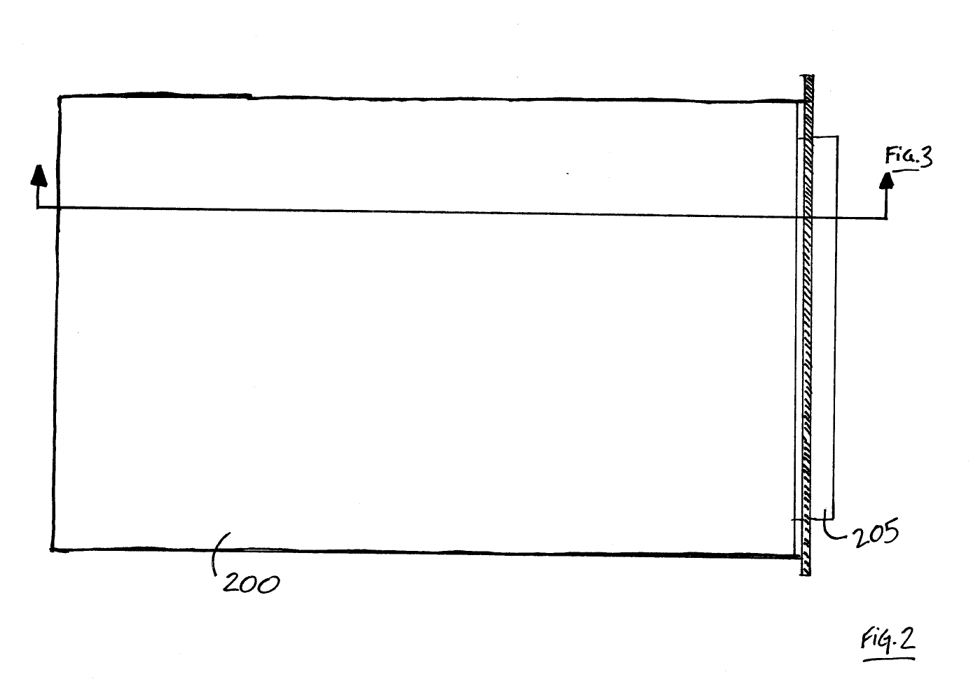

FIG. 2 is an audio-video unit 200 that utilizes various embodiments of the invention shown from a top view. The audio-video unit 200 features a transparent cover plate 205, which protrudes from the front of the audio-video unit 200.

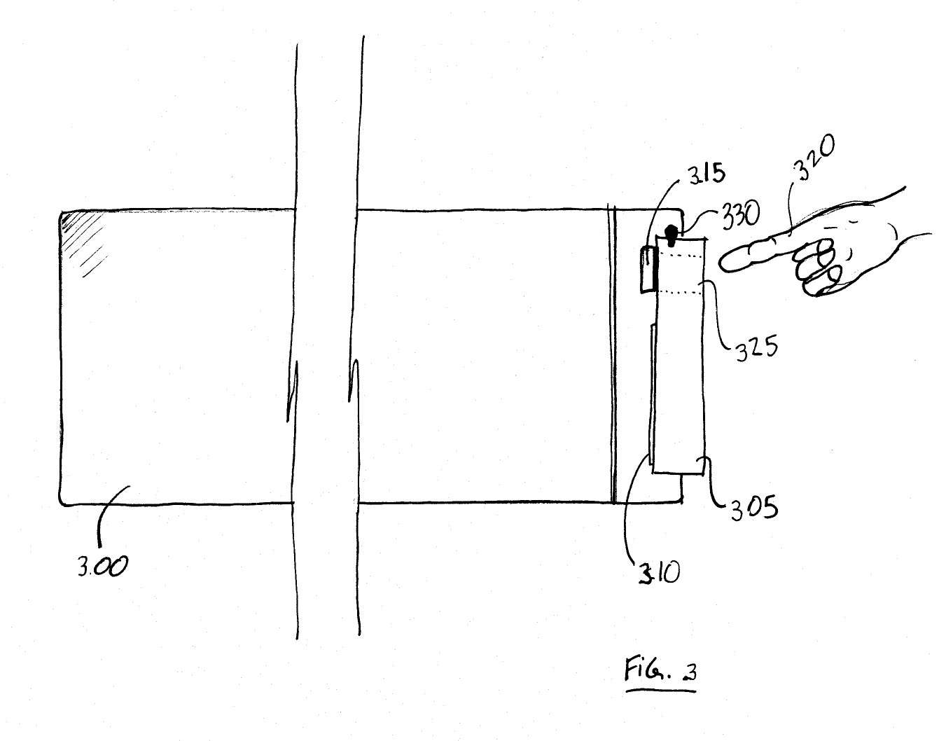

FIG. 3 is an audio-video unit 300 that utilizes various embodiments of the invention shown from a cross-sectional view. The audio-video unit 300 features a transparent cover plate 305, which sits in front of the volume meters 310 and the one or more capacitive touch sensors 315. The capacitive touch sensor 315 is activated by touching the user's finger 320 to the portion of the transparent cover plate section 325 in front of the transparent cover plate 305. The audio-video unit 300 further features one or more LEDs 330, which are hidden from view and illuminate the transparent cover plate 305. In various embodiments of the invention, the LEDs 330 are colored red, green, and blue, or a combination of similar colors.

In various embodiments of the invention, by tapping the transparent cover plate section 325 in front of the capacitive touch sensor 315, the user is able to control the LEDs 330 lighted displays. For example, in various embodiments of the invention, by repeatedly activating the capacitive touch sensor 315, the user is able to cycle through various lighting modes. For example, the transparent cover plate 305 may be illuminated in blue, green, red, pink, yellow, aqua, and other such colors. In various other embodiments of the invention, the capacitive touch sensor may activate a feature that coordinates the tri-color LEDs 330 with the audio being transmitted through the unit. For example, a light show may coordinate with the audio being processed through the unit such that the intensity and color of the lights is correlated to the intensity and pitch of the music.

Other such programs are known in the art and remain within the contemplation of the invention.

Furthermore, in embodiments of the invention utilizing more than one capacitive touch sensor 315, the capacitive touch sensors 305 may be used in order to control other features of the audio-video unit 305, such as input, mode, volume, and other such common controls.

In this manner, the various embodiments of the invention overcome the shortcomings of the prior art by allowing the visual display area of the audio-video unit 300 to be further used as an area to transmit commands to the audio-video unit 300.

What is claimed is:

1. A system for controlling one or more functions of an audio-video unit, comprising:
an audio-video unit having a front side,
said front side of said audio-video unit featuring a front display section, said front display section featuring a transparent cover plate covering said front display section and said front display section further comprising one or more capacitive touch sensors, said one or more capacitive touch sensors being located behind said transparent cover plate such that said one or more capacitive touch sensors are activated when the portion of said transparent cover plate adjacent to said one or more capacitive touch sensors is contacted by a user's finger, and
said audio-video unit further featuring one or more LEDs, said LEDs being configured to illuminate said transparent cover plate and said LEDs being configured such that they are controlled by a user by activating said transparent cover plate.

2. A system for controlling one or more functions of an audio-video unit according to claim 1, wherein said front display section comprises one or more volume meters.

3. A system for controlling one or more functions of an audio-video unit according to claim 1, wherein one of said one or more capacitive touch sensors comprises a rectangular shaped section of said front display section.

4. A system for controlling one or more functions of an audio-video unit according to claim 1, wherein said LEDs comprise a red, green, and blue LED.

5. A system for controlling one or more functions of an audio-video unit according to claim 1, wherein one of said one or more capacitive touch sensors activates an LED controller that changes the color of said LEDs.

6. A system for controlling one or more functions of an audio-video unit according to claim 1, wherein one of said one or more capacitive touch sensors activates an LED controller that changes the color of said LEDs to produce a light show that coordinates with the audio being processed through the unit such that the intensity and color of the lights is correlated to the intensity and pitch of the music.

7. A system for controlling one or more functions of an audio-video unit according to claim 1, wherein the edges of said transparent cover plate are etched.

8. A system for controlling one or more functions of an audio-video unit according to claim 1, said transparent cover plate features etched areas that communicate information to the user.

9. A system for controlling one or more functions of an audio-video unit according to claim 1, said transparent cover plate comprises a glass transparent cover plate.

10. A system for controlling one or more functions of an audio-video unit according to claim 1, said transparent cover plate comprises an acrylic glass transparent cover plate.

11. A system for controlling one or more functions of an audio-video unit according to claim 1, said transparent cover plate comprises a plastic transparent cover plate.

12. A system for controlling one or more functions of an audio-video unit, comprising:
an audio-video unit having a front side, said front side serving as a user interface for said audio-video unit,
said front side of said audio-video unit featuring a front display section, said front display section featuring a transparent cover plate covering said front display section, and said front display section further comprising one or more capacitive touch sensors, said one or more capacitive touch sensors being located behind said transparent cover plate such that said one or more capacitive touch sensors are activated when the portion of said transparent cover plate adjacent to said one or more capacitive touch sensors is contacted by a user's finger,
said transparent cover plate comprising an acrylic glass transparent cover plate featuring etched edges and etched areas that convey information to the user, and
said audio-video unit further featuring one or more LEDs, said LEDs configured to illuminate said transparent cover plate and said LEDs being configured such that they are controlled by a user by activating said transparent cover plate.

13. A system for controlling one or more functions of an audio-video unit according to claim 12, wherein said LEDs comprise a red, green, and blue LED.
